(19) United States
(12) Patent Application Publication
(10) Pub. No.: US 2005/0224750 A1
(43) Pub. Date: Oct. 13, 2005

(54) Simple apparatus for producing chlorine dioxide gas

(76) Inventors: Seung-Hee Yang, Seoul (KR); In-O Kim, Kyunggi-do (KR)

Correspondence Address: Randolph A Smith;Smith Patent Office, 1901 Pennsylvania Ave N W, Suite 200, Washington, DC, 20006-3433, US

(21) Appl. No.: 10/512,645

(22) PCT Filed: Apr. 28, 2003
(86) PCT No.: PCT/KR03/00856

§ 371 Date: Oct. 27, 2004

(30) Foreign Application Priority Data
Apr. 29, 2002 (KR) 10-2002-0023394
Apr. 29, 2002 (KR) 10-2002-0023501

(51) Int. Cl. A01N 1/00

(52) U.S. Cl. 252/186.1

(57) ABSTRACT

The present invention relates to a simple apparatus for producing chlorine dioxide gas, and more specifically, a simple apparatus for producing chlorine dioxide gas in which a sand or silica gel layer, a chlorine dioxide producing layer and, if necessary, a coarse sand layer and a silica gel or zeolite layer sequentially fill the bottom of a tube, a number of solution-absorption holes are formed at the bottom of the tube, and a number of ClO₂ outlets are formed at the top of the tube. According to the apparatus of the invention, it is possible to instantly produce a small amount of chlorine dioxide in simple and safe manner or possible to safely preserve or provide a small amount of chlorine dioxide for a long time.

### TECHNICAL FIELD

The present invention relates to a simple apparatus for producing chlorine dioxide gas which is widely used as a disinfectant, a water treatment agent and a deodorant due to its strong oxidizing power, and more specifically, a simple apparatus for producing chlorine dioxide gas in which a sand or silica gel layer, a chlorine dioxide producing layer and, if necessary, a coarse sand layer and a silica gel or zeolite layer sequentially fill the bottom of a tube, wherein a number of solution-absorption holes are formed at the bottom of the tube, and a number of ClO₂ outlets are formed at the top of the tube.

### BACKGROUND ART

Chlorine dioxide, as an oxide of chlorine, is a pungent yellowish-green gas with a chlorine-like fishy odor. It has been reported that chlorine dioxide has a risk of explosion under high concentrations, such as under partial pressure of 30 mmHg or more. Despite the danger of explosion and difficulty of production, chlorine dioxide has been widely used for various purposes such as water purification plants, a textile mills, pulp mills, etc. since it not only has a strong and broad range of disinfecting power (against for viruses, bacteria, protozoa, fungi, and so forth) but also an excellent deodorizing and bleaching power.

However, chlorine dioxide has a characteristic in that it can readily be decomposed by light, water, etc. into Cl⁻, ClO₂⁻, ClO₃⁻, etc. at room temperature and thus has been difficult to utilize commercially. In order to solve these problems, various processes were introduced to stabilize chlorine dioxide.

The processes for preparing chlorine dioxide hitherto known utilize, in case of producing it in an acidic liquid phase in several hundred tons (as chlorine dioxide) per day, chlorine dioxide is produced from the starting material chlorate using a reducing agent (SO₂, HCl, CH₃OH, etc.).
2NaClO₃+H₂SO₃→2ClO₂+Na₂SO₄+H₂O

Also, in case of producing chlorine dioxide in several tens of kilograms (as chlorine dioxide), common inorganic acid (HCl, H₂SO₄) and chlorite are oxidized to produce chlorine dioxide.
5NaClO₂+4HCl→4ClO₂+5NaCl+2H₂O
Or, chlorite and hydrochloric acid and hypochlorite are reacted to produce chlorine dioxide.
2NaClO₂+NaClO+2HCl→2ClO₂+3NaCl+H₂O

Other processes for generating chlorine dioxide are known in which chlorite is oxidized with chlorine to generate chlorine dioxide. However, the chlorine dioxide produced by the above processes is an aqueous solution, not a gas, cannot be applied in a small scale and, in addition, the produced chlorine dioxide solution has a drawback in actual use because it is very unstable and suffers from risk of explosion in relatively high concentrations.

Recently, a process has been described in the U.S. Pat. No. 4,473,115 in which chlorine dioxide is absorbed into, as a source of active oxygen, an aqueous mixture selected from the group consisting of ozone, hydrogen peroxide, calcium, magnesium, sodium and urea peroxide, and alkali metals perphosphate, persulfate and perborate and a salt of alkali metal phosphate, sulfate, carbonate and borate. Additionally, U.S. Pat. No. 3,271,242 describes a process for heating chlorine dioxide by absorbing it into an aqueous solution of sodium borate peroxide while increasing the temperature.

However, the above processes require the addition of an active oxygen source such as ozone, peroxide, etc. in order to utilize radicals of peroxides, and also, in order to the stabilize chlorine dioxide, employ a procedure wherein an aqueous solution containing peroxides and a number of alkali salts should be prepared and then chlorine dioxide is absorbed into the solution. Therefore, they have drawbacks that the overall processes are complicated in that the constitution of the solution is complicated and a number of chemicals are required, thus uneconomical for use in this stabilized aspect.

### DISCLOSURE OF INVENTION

Therefore, the present inventors have been extensively studied in order to solve the above drawbacks involved in the conventional processes, and as a result found that a simple apparatus according to the present invention can solve the above mentioned problems, such as the complicity of the aqueous solution system, economically infeasible production costs, and instability, and at the same time can realize the instantaneous production of chlorine dioxide in a safe and convenient manner in a small scale, or can safely preserve chlorine dioxide over a long time in the required amounts, and completed using the present invention.

It is therefore an object of the present invention to provide an apparatus for instantaneously producing a small amount of chlorine dioxide in a safe and convenient manner while concurrently solving the problems of the complicity, economically infeasible production costs and instability of the aqueous solution system.

It is another object of the present invention to provide an improved apparatus for preparing chlorine dioxide that can solve the problems such as the risk of explosion upon preparation of chlorine dioxide and its easy decomposition by sunlight or water, etc. at normal temperatures.

It is a further object of the present invention to provide an apparatus for preserving a small amount of chlorine dioxide for a long period of time and generating it as the need arises, and a process for preparing chlorine dioxide using the same.

### BRIEF DESCRIPTION OF THE DRAWINGS

Further objects and advantages of the invention can be more fully understood from the following detailed description taken in conjunction with the accompanying drawings in which:

FIG. 1 is a schematic diagram of a simple chlorine dioxide generator according to one embodiment of the invention;

FIG. 2 is a schematic diagram of a simple chlorine dioxide generator according to another embodiment of the invention;

FIG. 3 is a schematic diagram of a small-scale chlorine dioxide generator in a controlled release pattern according to one embodiment of the invention; and

FIG. 4 is a schematic diagram of a small-scale chlorine dioxide generator in a controlled release pattern according to other embodiment of the invention.

### BEST MODE FOR CARRYING OUT THE INVENTION

According to one aspect of the invention, there is provided a simple apparatus for preparing chlorine dioxide which comprises a sand or silica gel layer, a chlorine dioxide producing layer and, if necessary, a coarse sand layer and a silica gel or zeolite layer which sequentially fills the bottom of a tube, wherein a number of solution-absorption holes are formed at the bottom of the tube, and a number of ClO₂ outlets are formed at the top of the tube.

Hereinafter, the simple chlorine dioxide generator of the present invention will be described in further detail.

The simple chlorine dioxide generator according to the first embodiment of the invention is an instantaneous type generator and is characterized in that a sand or silica gel layer, a chlorine dioxide producing layer and, if necessary, a coarse sand layer and a silica gel or zeolite layer sequentially fill the bottom of a tube, wherein a number of solution-absorption holes are formed at the bottom of the tube, and a number of ClO₂ outlets are formed at the top of the tube.

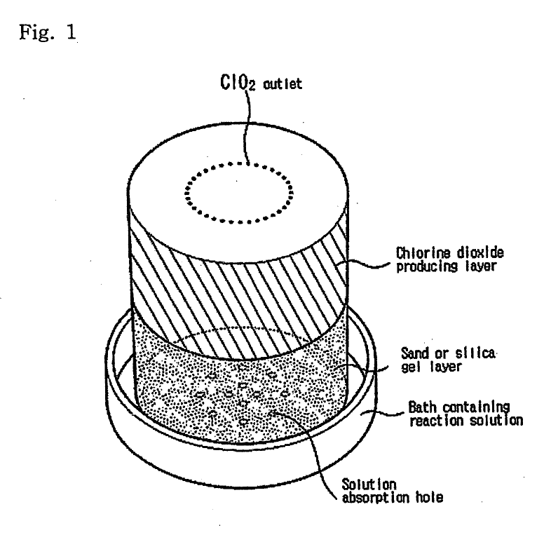

The above simple chlorine dioxide gas generator may take a cylindrical configuration as can be seen from FIG. 1. The structure of the generator may take any structure and cannot be limited to any specific structure provided that it has configuration wherein a number of ClO₂ outlets through which chlorine dioxide gas can be discharged is formed at the top of a tube, and the required water or diluted organic acid, inorganic acid or a hypochlorite solution can be well developed upward from the bottom of the tube. For example, the bottom can be formed with a number of small holes (solution absorption holes). The dimension of the apparatus according to the invention may not be limited by specific numerical means, but are illustrated for the purpose of easy understanding the invention. It is preferred that a number of small holes (for example, 3˜10) are perforated at the bottom of a glass tube with the diameter of 1˜5 cm and the holes are filled with a filter paper and pulp powder at thickness of 1˜2 cm so that the components of a sand or silica gel layer described later can not permeate the holes. There is no specific limitation on the length of the tube. At the bottom of the tube, sand or silica gel is filled up into a certain height, for example 2˜5 cm, so that the reaction solution can rapidly be developed upward. This sand or silica gel layer can preferably be substituted by other materials that satisfy the condition that the reaction solution can be rapidly developed upward. As an example thereof, the sand or silica gel layer may comprise only sand with various particle sizes, or may be filled with a combination of sand and silica gel. Also, this layer may preferably filled with a mixture of sand and chemical compounds, for example, NaHSO₄ powder, Ca(ClO)₂, etc. At the upper part of the sand or silica gel layer, a chlorine dioxide producing layer is placed by filling raw materials for producing chlorine dioxide in order to react with acids or hypochlorite. As the filler materials for producing chlorine dioxide, a mixture of chlorite (for example, NaClO₂), hypochlorite (for example, Ca(ClO)₂), NaHSO₄, or trichloroisocyanuric acid or dichloroisocyanurate (for example, sodium salt of dichloroisocyanuric acid), or a powder in which the above compounds are mixed in the molar ratio necessary for the chemical reaction are filled in order to easily generate chlorine dioxide and carbonate gas. In order to generate CO₂, various carbonates (Na₂CO₃, NaHCO₃, K₂CO₃, CaCO₃, MgCO₃, etc.) are filled into this layer. The carbonates play a role not only to generate carbon dioxide gas by contact with an acidic solution and then this gas pushes chlorine dioxide upward so that chlorine dioxide can be rapidly exhausted, but also to prevent the risk of explosion. As the acidic solution, NaH₂PO₄, NaHSO₄, organic acids with the pKₐ value less than 4, or inorganic acids can be selected. The organic acids include, such as for example, acetoacetic acid, adipic acid, m-, β-benzosulfonic acid, anisic acid, ascorbic acid, d-, l-aspartic acid, barbittiric acid, benzoic acid, benzosulfonic acid, bromoacetic acid, o-, m-bromobenzoic acid, chlorobenzoic acid, β-chlorobutyric acid, m-chlorocinnamic acid, o-, m-chlorophenoxyacetic acid, o-chlorophenylacetic acid, α-, β-chloropropionic acid, cis-cinnamic acid, citric acid, cyanoacetic acid, δ-cyanobutyric acid, cyanophenoxyacetic acid, cyanopropionic acid, cyclohexane-1,1-dicarboxylic acid, cyclopropane-1,1-dicarboxylic acid, dichloroacetic acid, dichloroacetylacetic acid, dihydroxybenzoic acid, dihydroxymalic acid, dihydroxytartaric acid, dimethylglycine, dimethylmalonic acid, dinicotinic acid, dinitrophenol, diphenylacetic acid, fluorobenzoic acid, formic acid, fumaric acid, furancarboxylic acid, furoic acid, glycolic acid, hippuric acid, o-hydroxybenzoic acid, iodoacetic acid, iodobenzoic acid, itaconic acid, lactic acid, lutidinic acid, maleic acid, malic acid, malonic acid, d-, l-mandelic acid, methylmalonic acid, methylsuccinic acid, naphthalenesulfonic acid, α-naphthoic acid, nitrobenzene, nitrobenzoic acid, nitrophenylacetic acid, oxalic acid, o-phenylbenzoic acid, o-, m-, p-phthalic acid, picric acid, quilnolinic acid, sulfanilic acid, tataric acid, terephtalic acid, thioacetic acid, thiophenecarboxylic acid, toluic acid, trihydorxybenzoic acid, trinitrophenol, uric acid, etc. As the inorganic acids, hydrochloric acid, phosphoric acid, sulfuric acid, and nitric acid solution can be used. Sulfuric acid may be representatively used, but an organic acid with a pKₐ value less than 4 may give similar results.

In the same manner as described above, the chlorine dioxide generator can be constituted by forming a number of small holes at the bottom of the apparatus through which water or inorganic acids, various organic acids with a pKa value less than 4, acidic salt solutions, etc. which are necessary for the reaction can be absorbed and passed, and by filling with sand or silica gel as the bottom layer of the apparatus so that the reaction solution can rapidly be developed upward through the chemically treated sand and silica gel with various particle sizes. And, if the generator is soaked in a vessel containing water or diluted acid and/or an aqueous acidic solution, the solution is absorbed and developed from the bottom to generate chlorine dioxide. Generally, chlorine dioxide gas with a yellowish green color and colorless carbon dioxide gas are generated in 5˜10 minutes after initiation of the reaction.

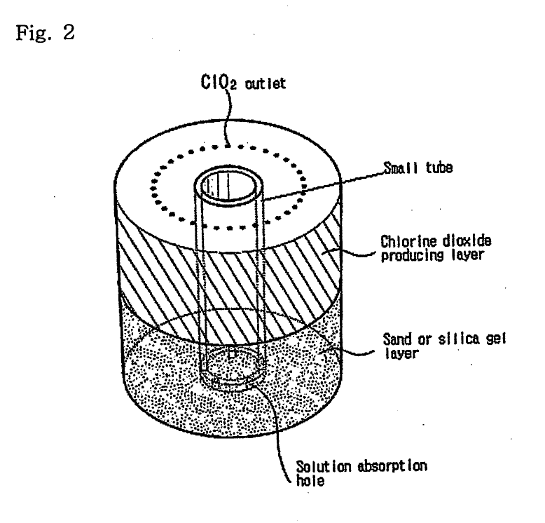

The simple chlorine dioxide gas generator of the invention according to the second embodiment of the invention may take a configuration, as can be seen from the FIG. 2, wherein a sand or silica gel layer and a chlorine dioxide producing layer sequentially fill the bottom of a tube, a number of ClO₂ outlets are formed at the top of the tube, and the bottom of the tube is closed. Instead, a tube with a smaller diameter is inserted in the central region of the vessel and a number of solution-absorption holes (for example, 2˜10 holes) having a diameter of 2mm are formed at the bottom of the small tube, and then the holes are filled with a filter paper and pulp powder so that the components of the sand or silica gel layer can not permeate the holes. This structure does not require the bath containing reaction solution and the inner tube serves as the reaction bath. According to the apparatus, chlorine dioxide is produced in a manner that the reaction solutions are developed upward through the sand layer from the bottom.

The simple chlorine dioxide gas generator according to the third embodiment of the invention is characterized in that a sand or silica gel layer, a chlorine dioxide producing layer, a coarse sand layer and a silica gel or zeolite layer sequentially fill the bottom of a tube, a number of ClO₂ outlets are formed at the top of the tube and a number of solution-absorption holes are formed at the bottom of the tube. This generator allows the slow release of chlorine dioxide in small amounts.

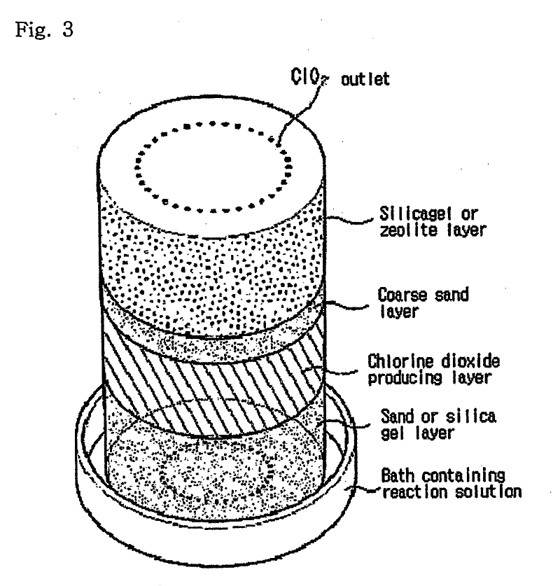

The simple chlorine dioxide gas generator according to the third embodiment of the invention may take a cylindrical configuration as can be seen from FIG. 3.

The structure of the generator may take any structure and cannot be limited to any specific structure provided that it has a configuration wherein a number of ClO₂ outlets through which chlorine dioxide gas can be discharged is formed at the top of a tube, and the required water or diluted organic acid, inorganic acid or a hypochlorite solution can be well developed upward from the bottom of the tube. For example, the bottom can be formed with a number of small holes (solution absorption holes).

The dimension of the apparatus according to the third embodiment may not be limited by specific numerical means, but are illustrated for the purpose of easy understanding the invention. It is preferred that a number of small holes (for example, 3˜10) are perforated at the bottom of a glass tube with the diameter of 1˜5 cm and the holes are filled with a filter paper and pulp powder at thickness of 1˜2 cm so that the components of the sand or silica gel layer described later can not permeate the holes. There is no specific limitation on the length of the tube, but 15˜30 cm length is preferable. At the bottom of the tube, sand or silica gel is placed as in the first embodiment of the invention. At the upper part of the sand or silica gel layer, chlorine dioxide producing layer, a coarse sand layer and a silica gel or zeolite layer are sequentially placed. The coarse sand layer is used in order to avoid the production of ions at the CO₂ production layer, which may comprise sand of various particle sizes, and if necessary may be treated with the compounds as illustrated in the examples. Coarse sand is preferable.

If the thus constituted apparatus (glass tube) is soaked into a vessel (bath containing reaction solution) containing water, diluted organic acid, inorganic acid or a hypochlorite solution, the reaction solution is stably and slowly developed into the upper layers while producing chlorine dioxide and carbon dioxide gases, and then the produced gases are readily stabilized by absorption into the upper located silica gel or zeolite layer. The absorbed chlorine dioxide is slowly diffused into air by diffusion phenomenon. Based on the above constitution, it is possible to safely provide chlorine dioxide in small amounts (mg unit) over a relatively long period of time.

The chlorine dioxide gas produced by the apparatus according to this preferred embodiment is very stable under normal pressure and room temperature and can be kept for a long time, and thus can suitably be used for desired disinfecting and deodorizing uses.

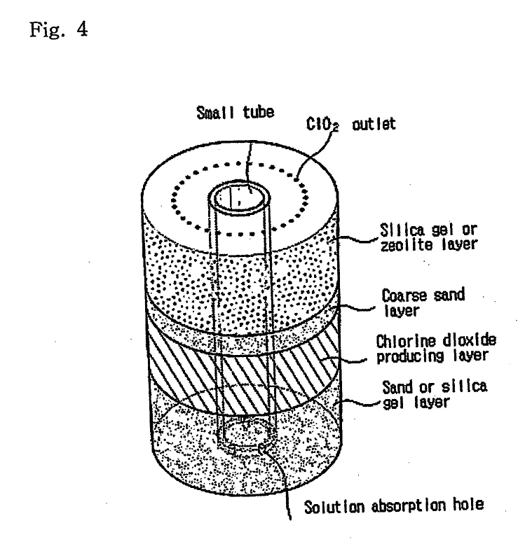

The simple chlorine dioxide gas generator according to the fourth embodiment of the invention may take a configuration, as can be seen from the FIG. 4, wherein a sand or silica gel layer, a chlorine dioxide producing layer and, a sand layer (a coarse sand layer) and a silica gel or zeolite layer sequentially fill the bottom of a tube, a number of ClO₂ outlets are formed at the top of the tube, and the bottom of the tube is closed. Instead a tube with a smaller diameter is inserted at the central region of the vessel and a number of solution-absorption holes (for example, 2˜10 holes) with a diameter of 2 mm are formed at the bottom of this small tube, and then the holes are filled with a filter paper and pulp powder so that the components of the sand or silica gel layer can not permeate the holes. This structure also does not require a bath containing reaction solution and the inner tube serves as the reaction bath. According to the apparatus, chlorine dioxide is slowly produced in a manner that the reaction solutions are developed upward from the bottom through the sand layer. The materials filling the tube are the same as those in the above third embodiment of the invention.

The present invention, in a further aspect, provides a process for instantaneously producing chlorine dioxide which is characterized in that it comprises sequentially filling a tube with a sand or silica gel layer, and chlorine dioxide producing layer from the bottom of the tube, forming at the bottom of the tube a number of holes which can absorb reaction solution, and developing as a reaction solution one or more acids selected from the group consisting of an inorganic acids such as sulfuric acid, hydrochloric acid, phosphoric acid, nitric acid or an organic acid with a pKa value less than 4. The constitution of each layer and the components are the same as described in the above.

The present invention, in a still further aspect, provides a process for producing small amounts of chlorine dioxide in a slow release pattern which is characterized in that it comprises sequentially filling a tube with a sand or silica gel layer, a chlorine dioxide producing layer, a sand layer and a silica gel or zeolite layer from the bottom, and forming at the bottom of the tube a number of holes which can absorb reaction solution, and developing as a reaction solution one or more acids selected from the group consisting of an inorganic acids such as sulfuric acid, hydrochloric acid, phosphoric acid, nitric acid, and an organic acid with a pKa value less than 4.

As fully described in the above, it is possible to instantaneously produce a small amount of chlorine dioxide or, if necessary, produce it over a long time by filling a glass tube with a powder layer in which the compounds are mixed in the molar ratio necessary for the chemical reaction to conveniently produce chlorine dioxide and carbon dioxide gas, and a chemically treated sand layer together with silica gel or zeolite, and utilizing, as an eluant, inorganic acids such as sulfuric acid, hydrochloric acid, nitric acid and phosphoric acid and phosphate (for example, NaHPO₄) and organic acids with a pKa value less than 4.

The feature of absorbing and stabilizing chlorine dioxide with the above silica gel or zeolite constitutes a still further aspect of the present invention. Therefore, the present invention, in a still further aspect, provides a process for stably preserving chlorine dioxide for a long time characterized in that chlorine dioxide is absorbed in silica gel or zeolite.

### EXAMPLES

The present invention will hereinafter be described in further detail by way of the examples. It should however be borne in mind that the scope of the present invention is not limited to or by the examples.

### Example 1

At the bottom of a glass tube with the length of 15 cm and diameter of 10 mm, 8 small holes were formed, and the holes were filled with a filter paper and pulp powder in a thickness of 1.5 cm. Then, a sand layer was covered thereon at a thickness of 2 cm. After filling up 4 g of NaClO₂ alone into the top of the glass tube and developing with a 5% sulfuric acid solution, chlorine dioxide was generated with the yield of 72%.

### Example 2

To the same apparatus as in Example 1, which was filled with the filter and sand, a thoroughly mixed powder of 2 g of NaClO₂ and 3 g of NaHCO₃ 3 g filled the top of the glass tube. As a result of developing with a 5% sulfuric acid solution, chlorine dioxide and carbon dioxide gases were rapidly produced. Yield: 82%.

### Example 3

To the same apparatus as in Example 1, which was filled with the filter and sand, a thoroughly mixed powder of 2 g of NaClO₂, 1.2 g of Ca(ClO)₂ and 1.5 g of Na₂CO₃ 1.5 g and an equal volume of sand filled the top of the glass tube. As a result of developing a 10% sulfuric acid or phosphoric acid solution, chlorine dioxide and carbon dioxide gases were rapidly produced. Yield: 80% or more.

### Example 4

To the same apparatus as in Example 1, which was filled with the filter and sand, an evenly mixed powder of 2 g of NaClO₂, 1.2 g of Ca(ClO)₂, 1.5 g of Na₂CO₃, 3 g of NaHCO₃ and 2.3 g of NaHSO₄ and two volumes of sand filled the top of the glass tube filter. As a result of developing a 10% inorganic acid, chlorine dioxide and carbon dioxide gases were rapidly produced. Yield: 92%.

### Example 5

To the same apparatus as in Example 1, which was filled with the filter and sand, an evenly mixed powder of 2 g of NaClO₂, 2.7 g of NaClO₃, 1.5 g of Na₂CO₃, 3 g of NaHCO₃ and 2 g of NaHSO₄ 2 g and two volumes of sand filled the top of the glass tube. As a result of developing a 5% of inorganic acid, chlorine dioxide and carbon dioxide gases were rapidly produced. Yield: 62%.

### Example 6

At the bottom of a glass tube with a diameter of 3 mm and the height of 20 cm, a sand layer was formed at a thickness of 3 cm. To the upper part thereof, a mixed powder of 4 g of NaClO₂ and 2.5 g of Na₂CO₃ was then added as the chlorine dioxide-producing layer. Then, another sand layer with particle size of 2˜3 mm was placed at a thickness of 0.3 cm. At the top of the tube, silica gel with a particle size of about 2˜3 mm was placed at a thickness of 6 cm, thereby constituting a slow release type of chlorine dioxide gas generator. Chlorine dioxide was continuously generated after soaking the above glass tube into a vessel containing a 5% of sulfuric acid solution. The generated gases were adsorbed on the silica gel adsorbent with the yield of about 76%.

### Example 7

The same tube as in Example 6 was used, and to the upper part of the sand layer at a thickness of 3 cm, a mixture of 5 g of NaHSO₄ powder and 3 cc of chemically treated sand layer was added. Then, the chlorine dioxide producing layer formed by mixing 5 cc of sand and an evenly mixed powder of 3 g of NaHCO₃, 1.5 g of Ca(ClO)₂, 1.3 g of Na₂CO₃, and 4 g of NaClO₂was added. To the upper part of this layer, a coarse sand layer with a particle size of 2˜3 mm and a silica gel layer were sequentially added at thickness of 0.5 cm and 6 cm, respectively. When the apparatus thus constituted was soaked into a vessel containing water, water was slowly passed through the sand layer and developed upward to give an acidic solution in which the acid was dissolved. Then, the solution slowly reacted with the chlorite layer to generate chlorine dioxide gas and carbon dioxide gas. The generated chlorine dioxide was adsorbed by the adsorbent as orange color or yellowish green color. Yields: 80% or more.

### Example 8

The same tube as in Example 6 was used, and to the upper part of the sand layer at a thickness of 3 cm, a mixture of 1.5 g of Ca(ClO)₂ g and a 2 cc of sand was used. Then, a chlorine dioxide producing layer made by mixing 2 cc of sand with 4 g of NaClO₂, 3 g of NaHCO₃, and 1.3 g of Na₂CO₃was added. To the top of the layer, a coarse sand layer and a silica gel layer were placed with thickness of 0.5 cm and 6 cm, respectively. When the tube thus constituted was soaked into a vessel containing 5% sulfuric acid, an acidic solution was slowly developed upward to give hypochlorite, and this was reacted with chlorous acid to generate chlorine dioxide. The generated chlorine dioxide was adsorbed by the silica gel absorbent together with the co-generated carbon dioxide gas. The use of other organic acids or inorganic acids may give similar results. Yields: 85% or more.

### Example 9

The same tube as in Example 6 was used, and to the upper part of the sand layer at a thickness of 3 cm, a mixture of 3 g of NaHSO₄ and sand was added. Then, a chlorine dioxide producing layer constituted the mixture of 2 cc of sand with 3.5 g of NaHCO₃ and 4 g of NaClO₂was formed. To the top of this layer, a coarse sand layer and a silica gel layer were used with thickness of 0.5 cm and 6 cm, respectively. When the tube thus constituted was soaked into a vessel containing a 5% hypochlorite solution, hypochlorite was generated from the NaHSO₄ layer. Chlorine dioxide was generated while the solution was developed upward. The co-generated carbon dioxide gas was adsorbed on the silica gel adsorbent together with the generated chlorine dioxide gas. Yields: 85% or more.

### Example 10

The same tube as in Example 6 was used, and to the upper part of the sand layer, a mixture of 2 g of NaClO₂, 2.7 g of NaClO₃ 2.7 g and 3 g of NaHCO₃ 3 g and sand was added. When the glass tube thus constituted was soaked into a vessel containing a 5% sulfuric acid, the solution was developed upward to give chlorine dioxide and carbon dioxide gas. Yields: 85% or more.

### INDUSTRIAL APPLICABILITY

The chlorine dioxide produced by conventional techniques was hard to commercialize due to the instability against concentrations and light and had a risk of explosion at high concentrations. In addition, the chlorine dioxide produced in an aqueous solution, rather than a gas has problems, such as the complicity of the aqueous solution system, economically infeasible costs, and instability, and it could not be applied on a small scale. While with use of the chlorine dioxide generator of the invention having the above illustrated constitution, it is possible to rapidly produce a small amount of chlorine dioxide for the desired purposes in a safe and convenient manner and also possible to prepare chlorine dioxide in a slow release pattern since the chlorine dioxide adsorbed through zeolite, etc. is slowly exhausted into air by a diffusion phenomenon. The chlorine dioxide gas produced by the apparatus according to the invention is very stable under normal pressures and room temperatures and can be kept for a long time, and thus can be suitably used for desired disinfecting and deodorizing uses. Chlorine dioxide can be prepared with the yields of 70% or more.

1. A simple apparatus for instantaneously producing chlorine dioxide gas characterized in that a sand or silica gel layer, and a chlorine dioxide producing layer sequentially fill the bottom of a tube, a number of solution-absorption holes are formed at the bottom of the tube, and a number of ClO₂ outlets are formed at the top of the tube.

2. The apparatus according to claim 1, wherein the bottom of the tube is closed, a tube with a small diameter is inserted at the central region of the vessel and a number of solution-absorption holes are formed at the bottom of the small tube.

3. The apparatus according to claim 1, wherein a filler material of the chlorine dioxide producing layer is selected from the group consisting of NaClO₂, Ca(ClO)₂, NaHSO₄, trichloroisocyanuric acid, dichloroisocyanurate, and carbonates selected from the group consisting of Na₂CO₃, NaHCO₃, K₂CO₃, CaCO₃, and MgCO₃, and the mixture thereof.

4. A process for producing chlorine dioxide characterized in that it comprises sequentially filling a sand or silica gel layer, and a chlorine dioxide producing layer from the bottom of a tube, forming at the bottom of the tube a number of holes which can absorb a reaction solution, and developing as a reaction solution one or more acids selected from the group consisting of inorganic acids such as sulfuric acid, hydrochloric acid, phosphoric acid, nitric acid and organic acids with a pKa value less than 4.

5. A slow-release type chlorine dioxide generator for small amounts characterized by a sand or silica gel layer, a chlorine dioxide producing layer, a coarse sand layer and a silica gel or zeolite layer sequentially filling the bottom of a tube, a number of solution-absorption holes formed at the bottom of the tube, and a number of ClO₂ outlets formed at the top of the tube.

6. The slow-release type chlorine dioxide generator according to claim 5, wherein the bottom of the tube is closed, a tube with a small diameter is inserted at the central region of the generator and a number of solution-absorption holes are formed at the bottom of the small tube.

7. The generator according to claim 5, wherein a filler material of the chlorine dioxide producing layer is selected from the group consisting of NaClO₂, Ca(ClO)₂, NaHSO₄, trichloroisosinuric acid, dichloroisocynurate, carbonates selected from the group consisting of Na₂CO₃, NaHCO₃, K₂CO₃, CaCO₃, and MgCO₃, and the mixture thereof.

8. The generator according to claim 5, wherein said sand layer is mixed with NaHSO₄ powder, and/or Ca(ClO)₂.

9. A process for producing small amount of chlorine dioxide in a slow release pattern characterized in that it comprises a sand or silica gel layer, a chlorine dioxide producing layer, a sand layer and a silica gel or zeolite layer sequentially filling the bottom of a tube, and forming at the bottom of the tube a number of holes which can absorb a reaction solution, and developing as a reaction solution one or more acids selected from the group consisting of inorganic acids such as sulfuric acid, hydrochloric acid, phosphoric acid, nitric acid and organic acids with a pKa value less than 4.

10. A process for stably preserving chlorine dioxide over a long time characterized in that chlorine dioxide is adsorbed in silica gel or zeolite.

11. The apparatus according to claim 2, wherein a filler material of the chlorine dioxide producing layer is selected from the group consisting of NaClO₂, Ca(ClO)₂, NaHSO₄, trichloroisocyanuric acid, dichloroisocyanurate, and carbonates selected from the group consisting of Na₂CO₃, NaHCO₃, K₂CO₃, CaCO₃, and MgCO₃, and the mixture thereof.

12. The generator according to claim 6, wherein a filler material of the chlorine dioxide producing layer is selected from the group consisting of NaClO₂, Ca(ClO)₂, NaHSO₄, trichloroisosinuric acid, dichloroisocynurate, carbonates selected from the group consisting of Na₂CO₃, NaHCO₃, K₂CO₃, CaCO₃, and MgCO₃, and the mixture thereof.

13. The generator according to claim 6, wherein said sand layer is mixed with NaHSO₄ powder, and/or Ca(ClO)₂.
